(19) United States
(12) Patent Application Publication
(10) Pub. No.: US 2011/0294002 A1
(43) Pub. Date: Dec. 1, 2011

(54) Case for secondary battery and secondary battery including the same

(76) Inventor: Ha-Dong Kim, Yongin-si (KR)

(21) Appl. No.: 12/929,609

(22) Filed: Feb. 3, 2011

(30) Foreign Application Priority Data
May 31, 2010 (KR) 10-2010-0051020

(51) Int. Cl. H01M 2/08; H01M 2/02

(52) U.S. Cl. 429/185

(57) ABSTRACT

A case for a secondary battery and a secondary battery including the same, the case including a case body having an interior space therein, the case body having a top opening; a cap plate in the top opening of the case body, the cap plate having a joint surface facing a joint surface of the case body; and a sealing member on the joint surface of at least one of the case body and the cap plate.

### BACKGROUND

1. Field

Embodiments relate to a case for a secondary battery and a secondary battery including the same.

2. Description of the Related Art

Recently, as mobile devices are becoming more widely used, studies on secondary batteries used as their power sources have been actively conducted.

Secondary batteries may include, e.g., nickel-cadmium batteries, nickel-hydrogen batteries, nickel-zinc batteries, and lithium batteries. The secondary batteries may basically have a structure in which a jelly-roll type electrode assembly is sealed in the interior of a prismatic or cylindrical case. The electrode assembly may be formed by winding a positive electrode, a negative electrode, a separator interposed therebetween.

Such a case for a secondary battery has a structure in which the top of the case is opened and a cap plate is fixed to a top portion of a case body. The cap plate may be fixed to the case by performing welding at boundary points between a top surface of the case body and a top surface of the cap plate.

### SUMMARY

Embodiments are directed to a case for a secondary battery and a secondary battery including the same, which represents advances over the related art.

It is a feature of an embodiment to provide a case for a secondary battery in which a sealing structure is provided together with welding portions to the connection structure between a case body and a cap plate, so that the sealing performance in the interior of the case body can be entirely improved.

It is another feature of an embodiment to provide a case for a secondary battery in which the connection strength between a case body and a cap plate is increased, so that it is possible to minimize the phenomenon that the case body and the cap plate are separated from each other by an external impact.

It is another feature of an embodiment to provide a case for a secondary battery in which although welding portions between a case body and a cap plate are broken by an external impact, the sealing performance in the interior of the case body can be maintained.

It is another feature of an embodiment to provide a case for a secondary battery in which it is possible to prevent a laser beam from being flowed in the interior of a case body in the process of laser welding between the case body and a cap plate, so that it is possible to prevent the case body from being broken in the process of manufacturing the case.

It is another feature of an embodiment to provide a case for a secondary battery and a secondary battery including the same, in which the sealing performance between a case body and a cap plate is increased, thereby preventing occurrence of failure and enhancing productivity in the process of manufacturing the case.

At least one of the above and other features and advantages may be realized by providing a case for a secondary battery, the case including a case body having an interior space therein, the case body having a top opening; a cap plate in the top opening of the case body, the cap plate having a joint surface facing a joint surface of the case body; and a sealing member on the joint surface of at least one of the case body and the cap plate.

The cap plate may include an installation groove on the joint surface thereof, the sealing member being in the installation groove.

The case body may include an installation groove on the joint surface thereof, the sealing member being in the installation groove.

The cap plate may include a first installation groove on the joint surface thereof, the case body may include a second installation groove on the joint surface thereof, the second installation groove being opposite to the first installation groove, and the sealing member may be in the first and second installation grooves.

The sealing member may be continuously disposed along the joint surface of the at least one of the case body and the cap plate.

The sealing member may be discontinuously disposed on the joint surface of the at least one of the case body and the cap plate.

The case body may include a stepped portion on the top opening thereof, the cap plate may be mounted on the stepped portion, and the joint surface of the cap plate may include a mounting surface facing the joint surface of the case body, the joint surface of the case body including the stepped portion thereof.

The sealing member may be continuously disposed along the joint surface of the at least one of the case body and the cap plate.

The sealing member may be discontinuously disposed on the joint surface of the at least one of the case body and the cap plate.

The sealing material may include a heat-meltable material.

The heat-meltable material may include a low-temperature heat-meltable metal material, the low-temperature heat-meltable metal material having a melting temperature of about 700° C. or lower.

The heat-meltable material may include at least one of Sn, Ag, Ni, Cu and Zn.

The heat-meltable material may include a synthetic resin including polypropylene (PP) or polyethylene (PE).

At least one of the above and other features and advantages may also be realized by providing a secondary battery including the case of an embodiment; and an electrode assembly in the interior space of the case.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a schematic sectional view showing a connection structure between a case body and a cap plate of a secondary battery;

FIG. 2A illustrates an exploded sectional view of a case body, a sealing member and a cap plate in a case for a secondary battery according to an embodiment;

FIG. 2B illustrates a schematic sectional view showing a state in which the sealing member is formed on a stepped portion of the case body;

FIG. 2C illustrates a schematic sectional view showing a state in which the sealing member is formed on a bottom edge surface of the cap plate;

FIGS. 3A and 3B illustrate schematic plan views respectively showing cases in which the sealing member is continuously disposed and where the sealing member is locally or discontinuously disposed at an interval;

FIG. 4A illustrates a schematic sectional view showing a state in which a sealing member is formed between an outer edge surface of a cap plate and an inner wall of a case body in a case for a secondary battery according to another embodiment;

FIG. 4B illustrates a schematic sectional view showing a state in which an installation groove is formed in an outer edge surface of the cap plate and the sealing member is inserted into the installation groove;

FIG. 4C illustrates a schematic sectional view showing a state in which an installation groove is formed in an inner wall of the case body and the sealing member is inserted into the installation groove; and

FIG. 5 illustrates a schematic sectional view showing a state in which installation grooves are respectively formed in an outer edge surface of the cap plate and an inner wall of the case body and a sealing member is inserted into the installation grooves in a case for a secondary battery according to yet another embodiment.

### DETAILED DESCRIPTION

Korean Patent Application No. 10-2010-0051020, filed on May 31, 2010, in the Korean Intellectual Property Office, and entitled: “Case for Secondary Battery and Secondary Battery Including the Same” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another element, it can be directly on the other element, or intervening elements may also be present. In addition, it will also be understood that when an element is referred to as being “between” two elements, it can be the only element between the two elements, or one or more intervening elements may also be present. Like reference numerals refer to like elements throughout.

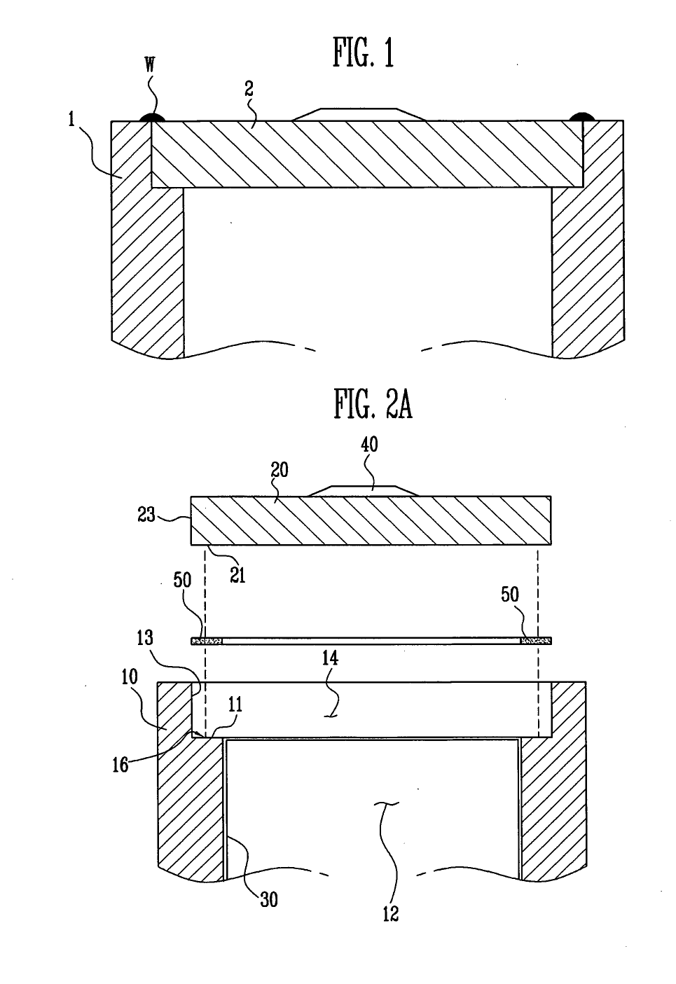

A case for a secondary battery is illustrated in FIG. 1. As shown in FIG. 1, the case may have a structure in which a cap plate 2 is inserted into a top portion of a box-type case body 1. Here, the top portion of the case body 1 may be open, and an accommodating space may be formed in an interior of the case body 1.

In this state, welding W may be performed at boundary points between a top surface of the case body 1 and a top surface of the cap plate 2, so that the case body 1 and the cap plate 2 may be fixed to each other and the interior of the case body 1 may be sealed.

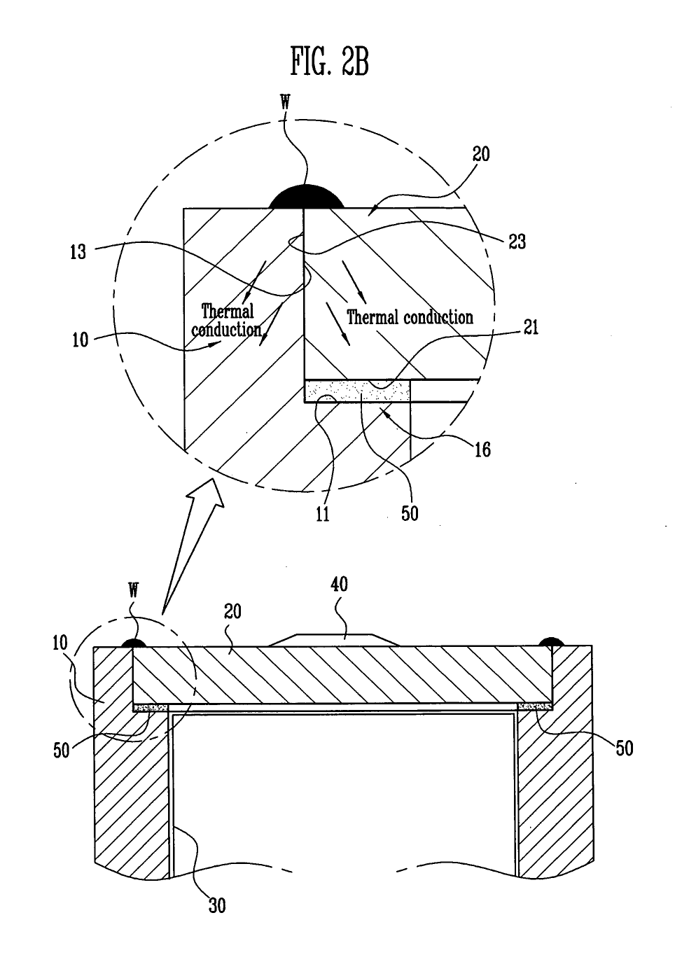

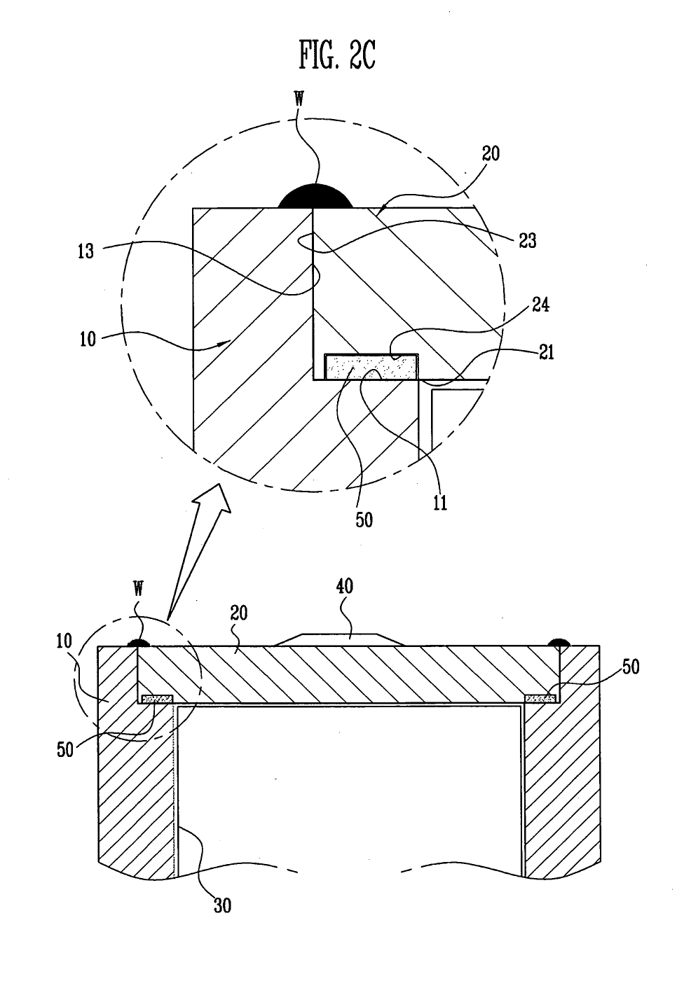

As shown in FIG. 2A, a case for a secondary battery according to an embodiment may include a case body 10 and a cap plate 20.

The case body 10 may serve as an entire body of the secondary battery as well as a negative electrode. The case body 10 may have a box-type structure in which an accommodating or interior space 12 for accommodating an electrode assembly 30 is formed in an interior of the case body 10. In addition, a bottom (not shown) of the case body 10 may be closed and may serves as a negative electrode terminal of the secondary battery. The top of the case body 10 may have an opening (hereinafter, referred to as a ‘top opening 14’) to accommodate having the electrode assembly 30 inserted into the interior thereof.

A stepped portion 16 for stable installation of the cap plate 20, which will be described below, may be formed on an inner wall of the top opening 14 of the case body 10.

The case body 10 may be made of, e.g., nickel (Ni), iron (Fe), and/or alloys thereof, and may be formed into a cylindrical or prismatic structure according to a desired kind of secondary battery. In the present embodiment, the case body 10 is formed into a prismatic structure.

For reference, the electrode assembly 30 in the interior of the case body 10 may be a structure at which current is substantially generated. The electrode assembly 30 may be formed into a jelly-roll structure by winding a positive electrode plate, a negative electrode plate, and a separator. Here, the positive electrode plate may be formed by coating a positive electrode active material layer on a surface of a positive electrode collector. The negative electrode plate may be formed by coating a negative electrode active material layer on a surface of a negative electrode collector. The separator may be interposed between the positive and negative electrode plates so that the positive and negative electrode plates are electrically isolated from each other.

In a state in which the electrode assembly 30 is positioned in the accommodating space 12 of the case body 10, the negative and positive electrode plates thereof may be respectively connected to a bottom of the case body 10, i.e., a negative electrode terminal, and a positive electrode terminal 40 of the cap plate 20, which will be described below.

Since the configuration known in the art is applied to the electrode assembly 30 according to this embodiment as it is, a detailed description of the electrode assembly 30 will be omitted.

The cap plate 20 inserted into the top opening 14 of the case body 10 may seal the interior of the case body 10 and may have the positive electrode terminal 40 formed thereon. The cap plate 20 may have a plate shape having the same form and area as the top opening 14 of the case body 10. The positive electrode terminal 40 may be formed on a center of the top of the cap plate 20.

As shown in FIG. 2B, the cap plate 20 may be inserted into the interior of the top opening 14 and then mounted on the stepped portion 16, so that a joint surface is formed between the cap plate 20 and the case body 10.

For convenience of illustration, a portion at which a bottom surface of the cap plate 20 is mounted on the stepped portion 16 is referred to as a first joint surface 21 and an outer edge surface of the cap plate 20 that comes in contact with an inner wall of the case body 10 is referred to as a second joint surface 23.

A surface of the stepped portion 16 corresponding to the first joint surface 21, i.e., mounting surface, of the cap plate 20 is referred to as a (1-1)-th joint surface 11 and a portion at which the inner wall of the case body 10 contacts the second joint surface 23 of the cap plate 20 is referred to as a (2-1)-th joint surface 13.

In the state in which the case body 10 and the cap plate 20 are joined together, laser welding W may be performed at boundary points between the top surfaces of the case body 10 and the cap plate 20, so that the case body 10 and the cap plate 20 are fixedly connected to each other.

In the connection structure between the case body 10 and the cap plate 20, a sealing member 50 for increasing fixing ability between the case body 10 and the cap plate 20 and improving sealing performance of the interior of the case body 10 may be further provided in addition to the welding.

As illustrated in FIGS. 2B and 2C, the sealing member 50 may be formed on the stepped portion of the case body 10, i.e., the (1-1)-th joint surface 11, or may be formed on the first joint surface 21 of the cap plate 20.

When the sealing member 50 is formed on the stepped portion 16 as shown in FIG. 2B, it may simply be mounted on the (1-1)-th joint surface 11. When the sealing member 50 is formed on the first joint surface 21 as shown in FIG. 2C, an installation groove 24 may be formed in the first joint surface 21 and the sealing member 50 may be inserted into the installation groove. Accordingly, it is possible to prevent the sealing member 50 from being separated in a process of connecting the cap plate 20 to the case body 10.

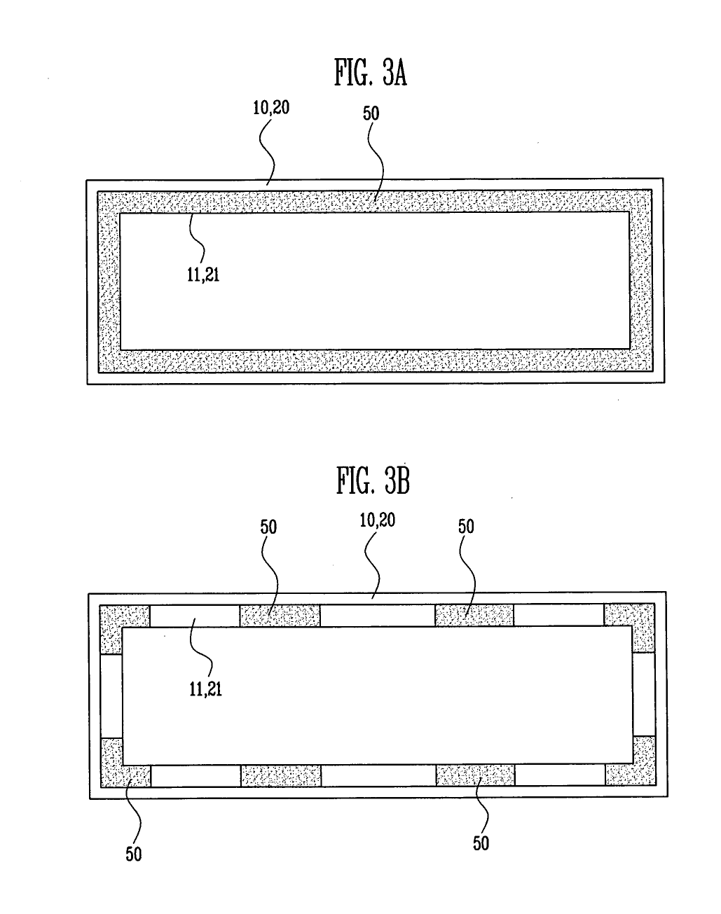

In both of the above-described methods, the sealing member 50 may be continuously disposed along the first joint surface 21 or the (1-1)-th joint surface 11, as shown in FIG. 3A. Alternatively, the sealing member may be locally or discontinuously disposed on the first joint surface 21 or the (1-1)-th joint surface 11 at an interval, as illustrated in FIG. 3B.

For reference, the structure in which the sealing member 50 is locally disposed may not have a higher sealing performance than the structure in which the sealing member 50 is continuously disposed. However, a connection function between the cap plate 20 and the case body 10 may be sufficiently performed using the structure in which the sealing member 50 is locally disposed.

The sealing member 50 having various shapes may be made of, e.g., a heat-melting or heat-meltable material. Particularly, the sealing member 50 may be made of a material having a melting temperature of about 700° C. or lower. In particular, the sealing member 50 may include a material having a melting temperature corresponding to a temperature of heat generated in the process of laser welding between the case body 10 and the cap plate 20.

In an implementation, the sealing member 50 may be made of, e.g., a heat-melting metal material or heat-melting resin material. When the sealing member 50 includes the heat-melting metal material, it may be implemented as a single or mixed material including at least one low-temperature heat-melting metal material, e.g., tin (Sn), silver (Ag), nickel (Ni), copper (Cu), and zinc (Zn).

The heat-melting metal material applicable to the sealing member 50 is not limited thereto. That is, any suitable material, e.g., a general soldering material, which may be melted at a temperature of about 700° C. or lower, may be included in the sealing member 50.

When the sealing member 50 includes the heat-melting resin material, it may be include, e.g., a polyimide-based single material or a compound obtained by compounding a polypropylene-based or polyethylene-based material therewith.

The heat-melting material may be applied to the sealing member 50 and the melting temperature may correspond to the welding temperature for reasons to be described below.

Hereinafter, operation and effect of the configuration according to the present embodiment will be described.

First, the process of connection between the cap plate 20 and the case body 10 will be schematically described. In the state in which the sealing member 50 is positioned on the (1-1)-th joint surface 11 or the first joint surface 21, the cap plate 20 may be mounted on the stepped portion 16 of the case body 10, i.e., the (1-1)-th joint surface 11, so that the sealing member 50 is positioned while being compressed between the (1-1)-th joint surface 11 and the first joint surface 21.

In this state, welding W may be performed at boundary points between the top surfaces of the cap plate 20 and the case body 10. In this case, as heat generated in the welding process being conducted on the cap plate 20 and the case body 10 as shown in FIG. 2B, the sealing member 50 may be melted by the conductive heat. Therefore, the sealing member 50 may be fixed to the first joint surface 21 and the (1-1)-th joint surface 11.

In this state, as the sealing member 50 is sintered after the welding is finished, the (1-1)-th joint surface 11 of the case body 10 and the first joint surface 21 of the cap plate 20 may be adhered to each other by the sealing member 50.

That is, the cap plate 20 and the case body 10 may have a structure in which they are double-welded by the welding portions W between their top surfaces as well as by the sealing member 50. As such, a number of connection portions between the top surfaces of the cap plate 20 and the case body 10 may be increased, so that the connection strength between the cap plate 20 and the case body 10 may also be increased.

Thus, even if an external impact is applied to the case, it is possible to prevent the cap plate 20 from being separated from the case body 10.

After welding between the case body 10 and the cap plate 20 is finished, a random free fall test may be performed to test the connection strength between the cap plate 20 and the case body 10. As the case body 10 and the cap plate 20 have a double-welded structure due to the sealing member, it is possible to minimize cracking of the welding portion between the cap plate 20 and the case body 10 due to impact in the random free fall test. Accordingly, failure detection rate may be remarkably reduced.

As the case body 10 and the cap plate 20 may have a double-welded structure due to the welding portions W between their top surfaces as well as the sealing member 50, the case according to the present embodiment may have a higher sealing performance than atypical case. Although the welding portion W may be broken by an external impact, the sealing structure of the case body 10 may be be maintained by the sealing member 50.

Thus, it is possible to prevent heat from a laser beam from flowing in the interior of the case body 10 through a gap of each of the joint surfaces in the process 50 is inserted into the installation groove 24, the installation groove 24 may also be continuously disposed in a rail shape or may be locally dipsosed at an interval, based on a shape of the sealing member 50.

In the present embodiment, the sealing member 50 may be naturally melted and then sintered in the process of welding between the top surfaces of the case body 10 and the cap plate 20. Accordingly, the case body 10 and the cap plate 20 may have a double connection and sealing structure including the welding portions W as well as the sealing member 50.

FIG. 5 illustrates a secondary battery according to yet another embodiment. The present embodiment is a modification of the immediately preceding embodiment. Specifically, asymmetrical first and second installation grooves 24 and 24b may be formed in the second joint surface 23 of the cap plate 20 and the (2-1)-th joint surface 13 of the case body 10, respectively.

Therefore, an integrated space portion may be formed between the first and second installation grooves 24 and 24b; and the sealing member 50 may be filled in the integrated space portion.

Any of the embodiments may be implemented into structures in which they are selectively combined. For example, the structures of the first and second embodiments may be combined. Alternatively, the structures of the first and third embodiments, the second and third embodiments, or the first, second and third embodiments may be combined.

In an implementation, although the sealing member described above is not necessarily formed of a heat-melting material, the sealing member may include any of laser welding between the case body 10 and the cap plate 20, thereby preventing the electrode assembly 30 from being damaged by the laser beam.

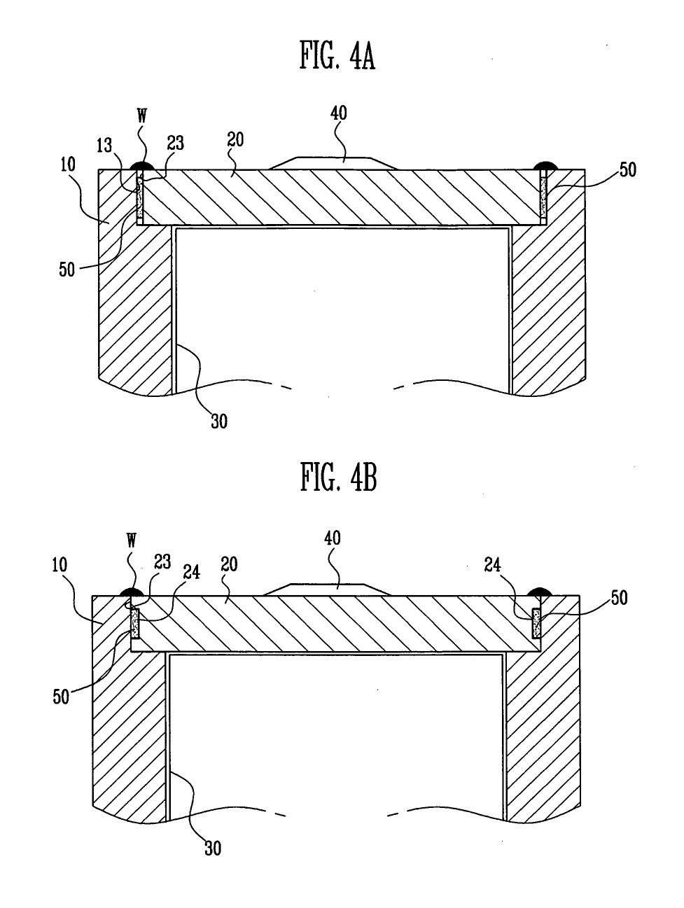

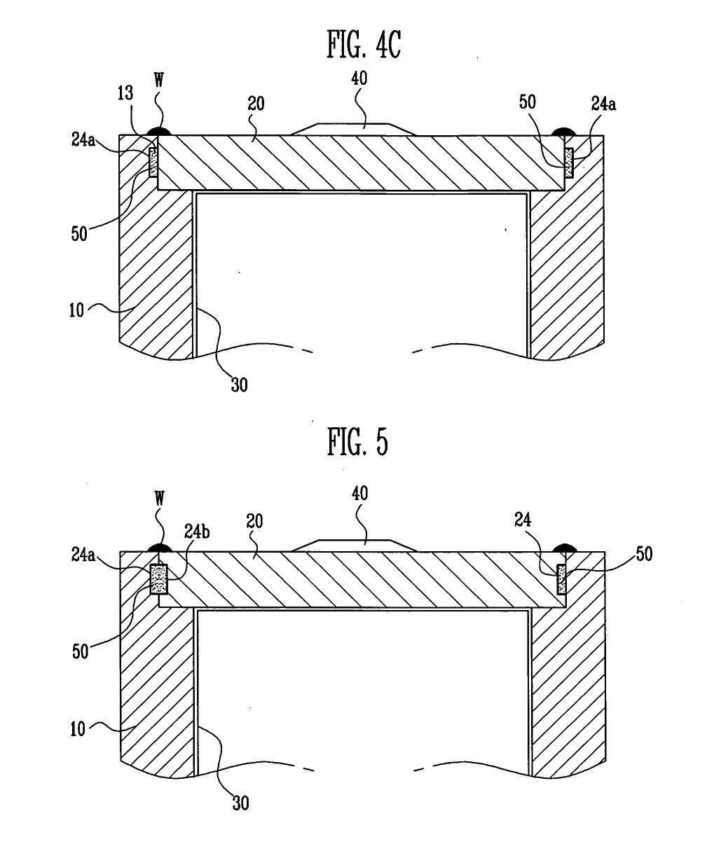

FIGS. 4A and 4B illustrates a case for a secondary battery according to another embodiment. The present embodiment is identical to the previous embodiment in that the sealing member 50 may be provided between the case body 10 and the cap plate 20. However, the present embodiment is different from the previous embodiment in that a position of the sealing member 50 is modified.

Specifically, the material and kind of the sealing member 50 in the present embodiment are identical to those of the sealing member of the previous embodiment. However the sealing member 50 may not be positioned on the (1-1)-th joint surface 11 or the first joint surface 21, but rather may be positioned between the second joint surface 23 and the (2-1)-th joint surface 13. As described above, the second joint surface 23 is an outer edge surface of the cap plate 20, and the (2-1)-th joint surface 13 is a surface of the case body 10, which corresponds to the second joint surface 23.

In this case, the sealing member 50 may be coated on the second joint surface 23 or the (2-1)-th joint surface 13, as illustrated in FIG. 4A or may be coated in an installation groove 24 in the second joint surface 23 as illustrated in FIG. 4B. Alternatively, in a state in which an installation groove 24 is formed in (2-1)-th joint surface 13, the sealing member 50 may be inserted in to the installation groove 24a as illustrated in FIG. 4C.

In the present embodiment, the sealing member 50 may be locally or discontinuously disposed on the second joint surface 23 at an interval or may be continuously disposed along the second joint surface 23. When the sealing member suitable material capable of performing fixing and sealing functions between the case body and the cap plate.

Various features of the embodiments described above may be modified and combined by those skilled in the art. However, the modification and combination provide a connection structure between a case body and a cap plate in which a separate sealing member is provided to a joint surface between the case body and the cap plate, so that a multiple connection and sealing structure between the case body and the cap plate is implemented by welding portions and the sealing member. Therefore, when the modification and combination are related to the configuration and object in which it is possible to improve the connection strength and sealing performance between the case body and the cap plate, they may be included in the protection scope of the present invention.

The connection structure between the case body and the cap plate according to an embodiment may have the following advantages.

First, the connection portion between the case body and the cap plate, i.e., the welding portion W may be formed at more than just the top surface because of the structure of the case. If an external impact is applied to the case in a state that the connection portion is formed without bias to one side, as described above, breaking of the welding portion may be prevented due to dispersion of the impact. As a result, the cap plate may remain coupled to the case body.

That is, as the connection portion between the cap plate and the case body may be formed without being biased to only the top of the case, sealing performance may be enhanced because resistive strength for external impact may be sufficient. Enhancing the integrity of the weld may likewise maintain sealing performance in the interior of the case body. Also, broadening of a space between the cap plate and the case body due to, e.g., connection error in the connection between the cap plate and the case body and the like, may be prevented.

As described above, according to the embodiments, the sealing structure between a case body and a cap plate may be additionally implemented by a sealing member, so that the sealing performance of the secondary battery may be entirely improved.

Also, as the sealing member may be made of a heat-melting material, the fixing and connecting function between the case body and the cap plate may be performed by welding portions and the sealing member. Hence, the connection strength between the case body and the cap plate may be increased. Accordingly, even if an external impact is applied to the case, it is possible to prevent the cap plate from being separated from the case body.

Further, since the sealing member may perform the connection function between the case body and the cap plate, the sealing performance in the interior of the case body may be maintained even if the welding portions are broken by an external impact.

Moreover, as the sealing member may naturally be melted by the conduction of heat generated in a welding process, a separate melting process of the sealing member may be rendered unnecessary, and rather the melting process may naturally be performed during a single welding process.

Additionally, as laser welding may be performed in the state that the sealing member is provided at the joint portion between the case body and the cap plate, it is possible to prevent heat of a laser beam from flowing in the interior of the case body. Accordingly, it is possible to prevent an electrode assembly from being broken by the laser beam.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A case for a secondary battery, the case comprising:
a case body having an interior space therein, the case body having a top opening;
a cap plate in the top opening of the case body, the cap plate having a joint surface facing a joint surface of the case body; and
a sealing member on the joint surface of at least one of the case body and the cap plate.

2. The case as claimed in claim 1, wherein the cap plate includes an installation groove on the joint surface thereof, the sealing member being in the installation groove.

3. The case as claimed in claim 1, wherein the case body includes an installation groove on the joint surface thereof, the sealing member being in the installation groove.

4. The case as claimed in claim 1, wherein:
the cap plate includes a first installation groove on the joint surface thereof,
the case body includes a second installation groove on the joint surface thereof, the second installation groove being opposite to the first installation groove, and
the sealing member is in the first and second installation grooves.

5. The case as claimed in claim 1, wherein the sealing member is continuously disposed along the joint surface of the at least one of the case body and the cap plate.

6. The case as claimed in claim 1, wherein the sealing member is discontinuously disposed on the joint surface of the at least one of the case body and the cap plate.

7. The case as claimed in claim 1, wherein:
the case body includes a stepped portion on the top opening thereof,
the cap plate is mounted on the stepped portion, and
the joint surface of the cap plate includes a mounting surface facing the joint surface of the case body, the joint surface of the case body including the stepped portion thereof.

8. The case as claimed in claim 7, wherein the sealing member is continuously disposed along the joint surface of the at least one of the case body and the cap plate.

9. The case as claimed in claim 7, wherein the sealing member is discontinuously disposed on the joint surface of the at least one of the case body and the cap plate.

10. The case as claimed in claim 1, wherein the sealing material includes a heat-meltable material.

11. The case as claimed in claim 10, wherein the heat-meltable material includes a low-temperature heat-meltable metal material, the low-temperature heat-meltable metal material having a melting temperature of about 700° C. or lower.

12. The case as claimed in claim 10, wherein the heat-meltable material includes at least one of Sn, Ag, Ni, Cu and Zn.

13. The case as claimed in claim 10, wherein the heat-meltable material includes a synthetic resin including polypropylene (PP) or polyethylene (PE).

14. A secondary battery, comprising:
the case as claimed in claim 1; and
an electrode assembly in the interior space of the case.
